(19) United States
(12) Patent Application Publication
(10) Pub. No.: US 2026/0180190 A1
(43) Pub. Date: Jun. 25, 2026

(54) FEEDING APPARATUS, ANTENNA SYSTEM, AND BASE STATION

(71) Applicant: HUAWEI TECHNOLOGIES CO., LTD., Shenzhen (CN)

(72) Inventors: Xinming Liu, Xi'an (CN); Peifeng Hu, Xi'an (CN); Weihong Xiao, Dongguan (CN); Shaoshuai Zhang, Xi'an (CN)

(21) Appl. No.: 19/539,162

(22) Filed: Feb. 13, 2026

Related U.S. Application Data
(63) Continuation of application No. PCT/CN2024/098850, filed on Jun. 13, 2024.

(30) Foreign Application Priority Data
Aug. 15, 2023 (CN) 202311032252.8

(51) Int. Cl. H01Q 13/00; H01Q 1/24

(52) U.S. Cl. CPC H01Q 13/00; H01Q 1/246

(57) ABSTRACT

Embodiments of this application provide a feeding apparatus, an antenna system, and a base station. The feeding apparatus includes: a substrate, where the substrate includes a signal line, and the signal line is configured for electrical signal transmission; a housing, where the housing is disposed on the substrate, the housing includes a bottom wall and a side wall, and the side wall and the bottom wall enclose a plurality of cavities; and a plurality of functional circuits, where the plurality of functional circuits are respectively accommodated in the plurality of cavities, planes on which the plurality of functional circuits are located are perpendicular to the substrate, and the plurality of functional circuits are connected to the signal line through a stripline.

### CROSS-REFERENCE TO RELATED APPLICATIONS

This application is a continuation of International Application No. PCT/CN2024/098850, filed on Jun. 13, 2024, which claims priority to Chinese Patent Application No. 202311032252.8, filed on Aug. 15, 2023. The disclosures of the aforementioned applications are hereby incorporated by reference in their entireties.

### TECHNICAL FIELD

Embodiments of this application relate to the field of wireless communication technologies, and more specifically, to a feeding apparatus, an antenna system, and a base station.

### BACKGROUND

A beam tilt of a base station antenna may be implemented via electrical tilt or mechanical tilt. The electrical tilt saves manpower and material resources while offering better coverage effect than the mechanical tilt, thus playing an important role in network optimization.

A feed network is an important part of an antenna system. The feed network includes a phase shifter, used to adjust a phase of an antenna. Performance of the phase shifter directly affects performance of the entire base station antenna. Most phase shifters are rotary-disk phase shifters, in which a phase varies by rotating an arc brush. This arc-shaped transmission mode increases a footprint in a width direction, which is likely to affect an overall layout of the feed network and makes integration with other functional modules of the antenna system difficult, consequently affecting a layout of the entire antenna system.

### SUMMARY

Embodiments of this application provide a feeding apparatus, an antenna system, and a base station, enabling the feeding apparatus to be readily integrated with different functional modules of the antenna system, thereby achieving a flexible layout of the antenna system.

According to a first aspect, a feeding apparatus is provided, including: a substrate, where the substrate includes a signal line, and the signal line is configured for electrical signal transmission; a housing, where the housing is disposed on the substrate, the housing includes a bottom wall and a side wall, and the side wall and the bottom wall enclose a plurality of cavities; and a plurality of functional circuits, where the plurality of functional circuits are respectively accommodated in the plurality of cavities, planes on which the functional circuits are located are perpendicular to the substrate, and the functional circuits are connected to the signal line through a stripline.

In this embodiment provided in this application, the substrate may be used as a bottom plate to carry components such as the housing and the functional circuits, and the bottom wall and the side wall of the housing enclose the plurality of cavities to accommodate the plurality of functional circuits, so that the feeding apparatus can easily integrate a plurality of functional modules of an antenna system, thereby implementing a flexible layout of the antenna system. The planes on which the functional circuits are located are perpendicular to the substrate, so that substrate space occupied by each functional module of the substrate can be effectively reduced, thereby implementing miniaturization of the feeding apparatus. Further, different functional modules may be combined, to implement expansion and derivation of functions of the feeding apparatus. That the plurality of functional circuits are respectively accommodated in the plurality of cavities can further improve isolation between the functional circuits and resolve a problem of coupling between the functional circuits, and functional modules in different cavities can be separately optimized to improve design efficiency. In addition, each modular circuit can be easily standardized in design, making the modular circuit applicable to all feeding apparatuses in a same architecture.

With reference to the first aspect, in some implementations of the first aspect, the housing further includes a spacer, the spacer is disposed in the cavity, and the spacer divides the cavity into a plurality of parts.

In this embodiment provided in this application, the housing includes the spacer, the spacer divides the cavity into the plurality of parts, and the plurality of parts each can accommodate a functional circuit. This can improve utilization of internal cavity space, so that the feeding apparatus can integrate more functional modules, thereby implementing integration and modularization of the feeding apparatus. In addition, this can implement three-dimensional wiring of the feeding apparatus, and reduce occupation of surface space of the substrate, thereby implementing miniaturization of the feeding apparatus.

With reference to the first aspect, in some implementations of the first aspect, the plurality of cavities include a first cavity and a second cavity, and an extension direction of the first cavity is parallel to or perpendicular to an extension direction of the second cavity.

In this embodiment provided in this application, the plurality of cavities include cavities that are parallel to or perpendicular to each other, so that flexibility of a spatial layout of the feeding apparatus can be improved, and surface space of the substrate is fully used to integrate different functional modules, thereby implementing miniaturization of the feeding apparatus.

With reference to the first aspect, in some implementations of the first aspect, there are a plurality of housings, and the plurality of housings are disposed on a same principal plane of the substrate.

In this embodiment provided in this application, the plurality of housings are disposed on the same principal plane of the substrate, so that the plurality of housings can be easily welded at a time, production and processing efficiency of the feeding apparatus can be improved, and miniaturization of the feeding apparatus can be easily implemented, thereby reducing space occupied by the feeding apparatus.

With reference to the first aspect, in some implementations of the first aspect, the feeding apparatus further includes a sliding medium, and the sliding medium is slidable relative to the plurality of functional circuits.

In this embodiment provided in this application, the feeding apparatus includes the sliding medium, and the sliding medium is slidable relative to the functional circuit, so that a phase adjustment function of the feeding apparatus can be implemented.

With reference to the first aspect, in some implementations of the first aspect, the functional circuit and a corresponding housing together constitute a functional module, and the functional module includes at least one of the following modules: a phase shift module, a power division module, a phase compensation module, a main feed module, a combiner, and a filter.

In this embodiment provided in this application, the plurality of functional circuits each may form at least one of the phase shift module, the power division module, the phase compensation module, the main feed module, the combiner, and the filter with the corresponding housing, so that the feeding apparatus can integrate different functional modules, thereby implementing modularization and miniaturization of the feeding apparatus.

With reference to the first aspect, in some implementations of the first aspect, the signal line is further configured to form at least one of the following functional modules of the feeding apparatus: a power division module, a phase compensation module, a main feed module, a combiner, a filter, and a transit network.

In this embodiment provided in this application, the signal line may form at least one of the power division module, the phase compensation module, the main feed module, the combiner, the filter, and the transit network, so that the feeding apparatus can integrate different functional modules, thereby implementing modularization and miniaturization of the feeding apparatus.

With reference to the first aspect, in some implementations of the first aspect, the substrate further includes a ground plane, and the bottom wall is electrically connected to the ground plane.

In this embodiment provided in this application, the substrate includes the ground plane, and the bottom wall of the housing is electrically connected to the ground plane, so that the feeding apparatus can be grounded.

With reference to the first aspect, in some implementations of the first aspect, the signal line and the ground plane are located on a same principal plane of the substrate, and the signal line and the ground plane form a coplanar waveguide structure; or the signal line and the ground plane are respectively located on different principal planes of the substrate, and the signal line and the ground plane form a microstrip or stripline structure.

In this embodiment provided in this application, when the signal line and the ground plane are located on a same plane to form a coplanar waveguide structure, wiring between the plurality of functional circuits can be simpler, and production costs of the feeding apparatus can be reduced; or when the signal line and the ground plane are located on different planes to form a microstrip or stripline structure or the like, surface space of the substrate can be fully used, and miniaturization of the feeding apparatus is implemented.

With reference to the first aspect, in some implementations of the first aspect, a side that is of the housing and that is away from the substrate includes an opening part, two adjacent functional circuits respectively include bent parts, and the bent parts of the two adjacent functional circuits are connected through the opening part.

In this embodiment provided in this application, the two adjacent functional circuits each may include the bent part, and the bent parts of the two adjacent functional circuits are connected through the opening part, so that a quantity of parts used by the feeding apparatus can be reduced, thereby implementing miniaturization of the feeding apparatus.

With reference to the first aspect, in some implementations of the first aspect, the housing includes a first opening, and the strip passes through the first opening to electrically connect to the signal line.

In this embodiment provided in this application, the housing includes the first opening, so that the strip passes through the first opening to connect to the signal line, and there is no need of wiring outside the housing to implement electrical connection, thereby making wiring in the feeding apparatus simpler.

With reference to the first aspect, in some implementations of the first aspect, the substrate includes a second opening, the second opening extends in a direction perpendicular to the principal plane of the substrate, and the strip passes through the first opening and the second opening to electrically connect to the signal line.

In this embodiment provided in this application, when the signal line and the housing are located on different planes of the substrate, the substrate may include the second opening, so that the strip separately passes through the first opening and the second opening to electrically connect to the signal line, and there is no need of wiring outside the housing and the substrate to implement electrical connection, thereby making wiring in the feeding apparatus simpler.

With reference to the first aspect, in some implementations of the first aspect, the substrate includes one or more cable outlets, and the cable outlet is disposed on a periphery of the substrate and is configured to connect the signal line to an antenna element or another radio frequency system; or the substrate includes one or more pins, and the pin is disposed on a periphery of the substrate and is configured to connect the signal line to an antenna element or another radio frequency system.

In this embodiment provided in this application, the substrate includes the cable outlet or the pin, so that the feeding apparatus can be connected to the antenna system or the another radio frequency system, to implement integration and modularization of the antenna system and the another radio frequency system.

According to a second aspect, an antenna system is provided, including the feeding apparatus according to the first aspect and any possible implementation of the first aspect, and one or more antenna elements. The one or more antenna elements are connected to the feeding apparatus.

According to a third aspect, a base station is provided, including the antenna system according to the second aspect and a radio frequency module connected to the antenna system.

### BRIEF DESCRIPTION OF DRAWINGS

FIG. 1 is a diagram of an architecture of an antenna system;

FIG. 2 is a diagram of an internal structure of an antenna;

FIG. 3 is a diagram of a structure of a feeding apparatus according to an embodiment of this application;

FIG. 4 is a diagram of a structure of a feeding apparatus according to an embodiment of this application;

FIG. 5 is a diagram of a structure of a feeding apparatus according to an embodiment of this application;

FIG. 6 is a diagram of a structure of a feeding apparatus according to an embodiment of this application;

FIG. 7 is a diagram of a structure of a feeding apparatus according to an embodiment of this application;

FIG. 8 is a diagram of a structure of a feeding apparatus according to an embodiment of this application; and

FIG. 9 is a diagram of a structure of a feeding apparatus according to an embodiment of this application.

### DESCRIPTION OF EMBODIMENTS

The following describes technical solutions in embodiments of this application with reference to accompanying drawings.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner.

Terms “include”, “contain”, “have”, and their variants all mean “include but not limited to”, unless otherwise specifically emphasized in another manner.

In embodiments of this application, “first”, “second”, and the like are merely intended to indicate that a plurality of objects are different. For example, a first cavity and a second cavity are merely used to represent different cavities. The terms should impose no impact on the cavities and quantities thereof. “First”, “second”, and the like described above should not impose any limitation on embodiments of this application.

FIG. 1 is a diagram of an architecture of a base station antenna system according to an embodiment of this application. The base station antenna system may include components such as an antenna 101, a feeder 103, a pole 104, a remote radio unit (remote radio unit, RRU) 102, and a grounding apparatus 105. The antenna 101 may be fixed on the pole 104 using an adjustable bracket or the like, and may be connected to the RRU 102 through the feeder 103 for signal transmission with the RRU 102 through the feeder 103. The antenna 101 may be further connected to the grounding apparatus 105.

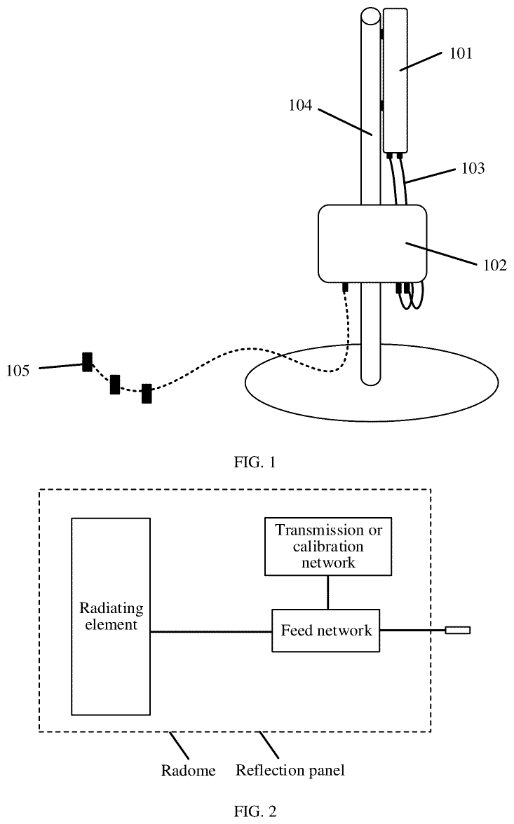

FIG. 2 shows main internal components of an antenna. The antenna may include a radiating element, a feed network, a transmission or calibration network, a radome, a reflection panel, and the like.

The radiating element is a basic structural unit of an antenna array, and is configured to radiate or receive a radio wave. The radiating element may also be referred to as an antenna element, an element, or the like. One antenna array may include one or more radiating elements, and frequencies of different radiating elements may be the same or may be different.

The feed network is configured to feed a signal to the radiating element based on a specific amplitude and phase, or send a received signal to a signal processing unit of a base station based on a specific amplitude and phase. The feed network may be connected to the transmission network to implement different radiation beam directions. The feed network may alternatively be connected to the calibration network to obtain a system-required calibration signal. The feed network usually includes controlled impedance transmission lines. The feed network may include a phase shifter, and in some cases, may further include components such as a combiner and a filter.

The radome is a mechanical part configured to protect the antenna system from an external environment. The radome has good electromagnetic wave penetrability in terms of electrical performance and can withstand an adverse external environment in terms of mechanical performance. Components such as the radiating element, the transmission or calibration network, and the feed network may be accommodated in the radome.

The reflection panel may also be referred to as a bottom plate, an antenna panel, a metal reflective surface, or the like; and can improve receiver sensitivity of an antenna signal, reflect and aggregate the antenna signal on a receiving point, and can block or shield interference of another electromagnetic wave from a reverse direction on a received signal. The radiating element is generally placed above the reflection panel.

The antenna may further include an antenna connector, configured to connect the antenna to an external feeder, so that the antenna is connected to an RRU and the like.

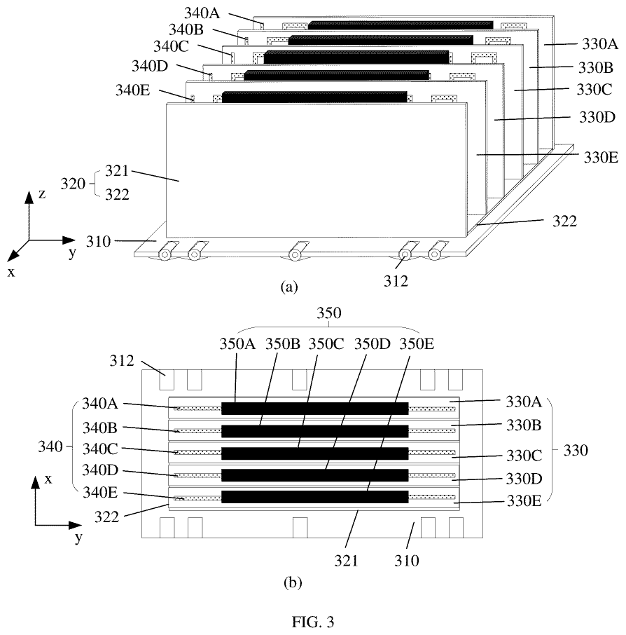

A feeding apparatus provided in embodiments of this application may be disposed in the antenna. The feeding apparatus may also be referred to as a feed network, and is configured to adjust an amplitude, a phase, and the like of a sent signal or a received signal. The following describes a structure of the feeding apparatus provided in embodiments of this application with reference to FIG. 3 to FIG. 9.

First, refer to a feeding apparatus shown in FIG. 3. (a) in FIG. 3 is a diagram of a three-dimensional structure of the feeding apparatus, and (b) in FIG. 3 is a top view of the feeding apparatus. The feeding apparatus may include a substrate 310, a housing 320, and a plurality of functional circuits 340.

The substrate 310 may be a printed circuit board (printed circuit board, PCB), a ceramic substrate, or the like. The substrate 310 may be a single-layer substrate, or may be a multi-layer substrate. The substrate 310 may include a signal line 311 configured for electrical signal transmission. The signal line 311 may be used as a transit network, and is configured to connect the plurality of functional circuits 340 to transfer electrical signals of one functional circuit 340 to another functional circuit 340, or may be configured to connect the feeding apparatus to another radio frequency circuit to transfer electrical signals of the feeding apparatus to the another radio frequency circuit.

The housing 320 may include a bottom wall 322 and a side wall 321, the bottom wall 322 may be carried on the substrate 310, and the bottom wall 322 and the side wall 321 may enclose a plurality of cavities 330. For example, the bottom wall 322 of the housing 320 may be parallel to the substrate 310 and is fixedly connected to the substrate 310, for example, through welding. The bottom wall 322 may be connected to an entire surface of the substrate 310, or may be fixedly connected to the substrate 310 through one or more protrusions on the substrate 310. The bottom wall 322 may alternatively be carried on the substrate 310 through coupling connection.

It should be noted that, in embodiments of this application, that two or more mechanical parts are parallel to each other may be that the two or more mechanical parts are approximately parallel to each other, and a specific angle error is allowed in a production and processing process. Similarly, in the following, that two or more mechanical parts are perpendicular to each other may be that the two or more mechanical parts are approximately perpendicular to each other, and that sizes are equal may mean that the sizes are approximately equal.

The housing 320 may include a plurality of side walls 321, and the plurality of side walls 321 may share one bottom wall 322, and enclose a plurality of cavities 330 with the bottom wall 322. For example, as shown in FIG. 3, the plurality of side walls 321 may be disposed in parallel to each other, and the plurality of side walls 321 may be perpendicular to the bottom wall 322, so that a single cavity 330 forms a “U”-shaped structure, and the housing 320 may be a semi-open housing. That the plurality of side walls 321 are disposed in parallel to each other means that extension directions of the plurality of cavities 330 enclosed by the plurality of side walls 321 and the bottom wall 322 may be the same, that is, the extension directions of the plurality of cavities 330 may be parallel to each other. The extension directions of the plurality of cavities 330 shown in FIG. 3 are a y-axis direction. The side walls 321 and the bottom wall 322 may be of an integrated structure, or may be connected through welding, screwing, or the like. The housing 320 is a semi-open housing, so that a weight and a size of the feeding apparatus can be effectively reduced, and manufacturing costs of the feeding apparatus can be reduced.

The housing 320 may also include a top wall (not shown in the figure). The top wall may be disposed on a side that is of the housing 320 and that is away from the substrate 310. In other words, the top wall may be disposed opposite to the bottom wall 322, that is, the top wall and the bottom wall 322 may be respectively disposed on upper and lower sides of the side wall 321 in a z-axis direction. The top wall, the bottom wall 322, and the side wall 321 may jointly enclose a closed cavity. In this example, the side walls 321 may include not only side walls 321 that are disposed in parallel in the figure, but also side walls 321 (not shown in the figure) disposed on left and right sides of the housing 320. The left and right sides are two sides of the housing 320 in the y-axis direction shown in the figure.

The plurality of functional circuits 340 may be respectively accommodated in the plurality of cavities 330 of the housing 320, and the plurality of functional circuits 340 may be respectively accommodated in the cavities 330 in a vertical manner, that is, a plane formed by the functional circuits 340 may be perpendicular to a plane on which the substrate 310 is located. For example, the functional circuits 340 may be formed by bending a stripline into alternating concave and convex zigzag structures, the alternating concave and convex zigzag structures may be located on a same plane, and the plane may be located on a yz plane shown in the figure, and is parallel to the side wall 321 and perpendicular to the substrate 310. The plurality of functional circuits 340 may be electrically connected to the signal line through the strip.

It should be noted that, in embodiments of this application, the functional circuit 340 may be a microwave circuit. From a structural perspective, the functional circuit 340 may be a stripline. From a functional perspective, the functional circuit 340, that is, a part that is of a stripline and that is located inside the cavity 330, may together constitute a functional module with the housing 320, and therefore is referred to as a functional circuit in embodiments of this application, and a part that is located outside the cavity 330 mainly performs an electrical connection function, and therefore is referred to as a stripline in embodiments of this application. In other words, the functional circuit and the strip may be a whole, but implement different functions because the functional circuit and the strip are disposed at different positions in the feeding apparatus. Alternatively, the functional circuit 340 and the strip may be two parts that are connected to each other, and are respectively disposed inside the cavity 330 and outside the cavity 330, to implement different functions.

The functional circuit 340 and the housing 320 may form a suspended strip structure, that is, the strip may be disposed in the cavity 330 and may not be in direct contact with the side wall 321 of the housing 320. The strip and a component such as the housing 320 may together constitute a functional module of the feeding apparatus, such as a power division module or a phase shift module.

In an example, the feeding apparatus may further include a sliding medium 350, and the sliding medium may slide relative to the functional circuit 340. The sliding medium 350 may be a material whose electrostatic constant is different from that of air, and is configured to change an electrostatic constant of a surrounding environment. When the sliding medium 350 slides relative to the functional circuit 340, an electrical length of a travel line can be changed, to implement phase adjustment. There may be a plurality of sliding media 350. For example, there may be five sliding media shown in the figure, and the five sliding media 350A, 350B, 350C, 350D, and 350E may be respectively disposed in cavities 330A, 330B, 330C, 330D, and 330E, and may respectively cover corresponding functional circuits 340A, 340B, 340C, 340D, and 340E in the cavities. For example, the sliding medium 350 may be of an inverted “U”-shaped structure, and the functional circuit 340 may be disposed below a middle gap of the inverted “U”-shaped structure. The sliding medium 350 may slide with respect to the functional circuit 340 in the y-axis direction shown in the figure. The sliding medium 350 may together constitute a phase shift module with the side wall 321 and the bottom wall 322 of the corresponding cavity 330 and the functional circuit 340 in the corresponding cavity 330. The five sliding media 350 may respectively form five phase shift modules with corresponding housings 320 and functional circuits 340, to implement phase adjustment. For example, the sliding medium 350A may form one phase shift module with the corresponding functional circuit 340A and the side wall 321 and the bottom wall 322 of the corresponding cavity 330A, and the sliding medium 350B may form one phase shift module with the corresponding functional circuit 340B and the side wall 321 and the bottom wall 322 of the corresponding cavity 330B. The same applies to 330C, 330D, and 330E.

Alternatively, the functional circuit 340 may together constitute a functional module such as a power division module, a phase compensation module, a combiner, or a filter with a part of housing 320 corresponding to the cavity 330 in which the functional circuit 340 is accommodated. This is not limited in this application.

According to the feeding apparatus provided in embodiments of this application, the substrate serves as a mother board to carry components such as the housing and the functional circuits, and the plurality of functional circuits can be respectively accommodated in the plurality of cavities of the housing, so that the feeding apparatus can easily integrate different functional modules, and different functional modules may be combined, to implement expansion and derivation of functions of the feeding apparatus. That the plurality of functional circuits are respectively accommodated in the plurality of cavities can further improve isolation between striplines in the cavities and resolve a problem of coupling between the striplines, and functional modules in different cavities can be separately optimized to improve design efficiency. In addition, each modular circuit can be easily standardized in design, making the modular circuit applicable to all feeding apparatuses in a same architecture.

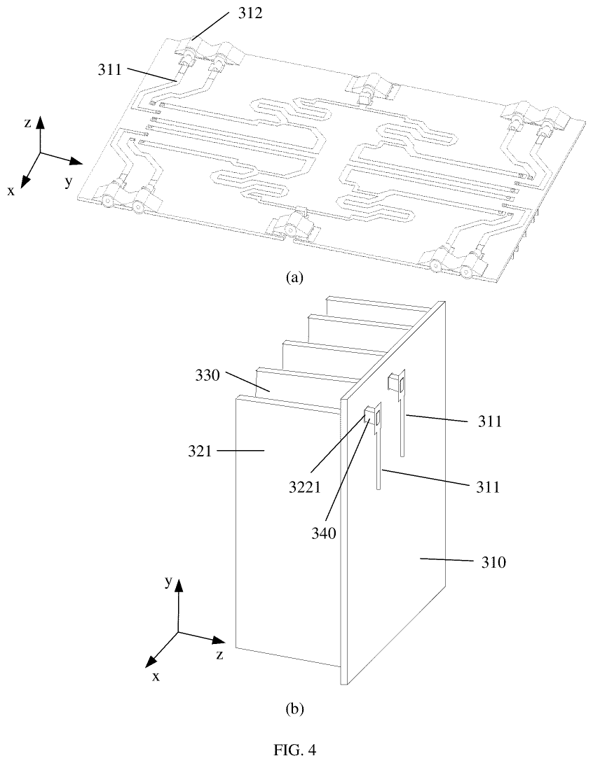

In some embodiments, the signal line 311 and the housing 320 may be respectively disposed on two principal planes of the substrate 310. The principal plane of the substrate 310 is a plane with a relatively large area of the substrate 310, for example, may be an xy plane shown in the figure. In other words, the signal line 311 and the housing 320 may be respectively disposed on upper and lower sides of the substrate 310 in the z-axis direction shown in the figure. A structure of the signal line 311 may be, for example, a structure shown in (a) in FIG. 4. The housing 320 may include a first opening (not shown in the figure), the first opening may be disposed on the side wall 321 of the housing 320, or may be disposed on the bottom wall 322 of the housing 320, and there may be one or more first openings. When the signal line 311 and the housing 320 are respectively disposed on the two principal planes of the substrate 310, the substrate 310 may also include a second opening 3221 (as shown in (b) in FIG. 4) at a corresponding position, and the second opening 3221 may extend in a direction perpendicular to the principal plane of the substrate 310, so that the strip can pass through the first opening and the second opening 3221 in sequence to electrically connect to the signal line. The housing 320 may also include an open surface (not shown in the figure), the open surface is an opening with a relatively large area on the housing 320, and the strip may pass through the open surface to connect to the signal line 311. That the signal line 311 and the housing 320 are respectively disposed on the two principal planes of the substrate 310 can improve utilization of surface space of the substrate 310 and effectively reduce a size of the feeding apparatus.

Alternatively, the signal line 311 and the housing 320 may be disposed on a same plane of the substrate 310. In this example, the second opening 3221 or the open surface may not need to be disposed on the substrate 310, and only the first opening needs to be disposed on the housing, so that the strip can pass through the first opening on the housing 320 to connect to the signal line 311. In this example, the signal line 311 may be disposed in an area outside a projection range of the housing 320 on the substrate 310 in the z-axis direction shown in the figure.

In some embodiments, the signal line 311 may further form a power division module of the feeding apparatus, to divide one input signal into two or more output signals for output. The power division module may jointly implement a phase shift function with a phase shift module, to implement antenna phase adjustment.

In some embodiments, the substrate 310 may further include a ground plane (not shown in the figure), the ground plane and the housing 320 may be disposed on a same principal plane of the substrate 310, and the housing 320 may be connected to the ground plane. The housing 320 may be directly electrically connected to the ground plane, or may be coupled to the ground plane. When the housing 320 is directly electrically connected to the ground plane, the housing 320 may be electrically connected to an entire surface of the ground plane, for example, the entire bottom wall 322 of the housing 320 may be connected to the ground plane. Alternatively, the ground plane may include one or more protrusions, and the housing 320 is connected to the ground plane through the one or more protrusions (not shown in the figure). The housing 320 may be fixed to and electrically connected to the ground plane through welding or the like.

When the ground plane and the housing 320 are disposed on different principal planes of the substrate 310, the housing 320 may be electrically connected to the ground plane through an opening on the substrate 310, and the opening on the substrate 310 may be a guide hole, that is, a metal object may be injected into the opening, to implement electrical connection between the housing 320 and the ground plane, so that the housing 320 is grounded.

The ground plane and the signal line 311 may be located on a same principal plane of the substrate 310, or may be located on different principal planes of the substrate 310. When the ground plane and the signal line 311 are located on different principal planes of the substrate 310, for example, when the ground plane and the housing 320 are located on a same principal plane of the substrate 310, or an upper plane of the substrate 310, that is, an upper plane of the substrate 310 in the z-axis direction, and the signal line 311 is located on a lower plane of the substrate 310, that is, a lower plane of the substrate 310 in the z-axis direction, the ground plane and the signal line 311 may form a microstrip structure, that is, a structure in which the signal line 311, the substrate 310, and the ground plane are sequentially disposed; or the ground plane and the signal line 311 may form a stripline structure. In other words, the signal line 311 may be of a multi-layer structure. For example, there may be two layers of signal lines 311, and another layer of substrate 310 is disposed between the two layers of signal lines 311. That the ground plane and the signal line 311 are located on different principal planes of the substrate 310 can fully use surface space of the substrate, and implement miniaturization of the feeding apparatus.

When the ground plane and the signal line 311 are located on a same principal plane of the substrate 310, for example, when both the ground plane and the signal line 311 are located on a same plane of the substrate 310 as the housing 320, that is, an upper plane of the substrate 310, the ground plane and the signal line 311 may form a coplanar waveguide structure. When the signal line 311 and the ground plane are located on the same plane to form the coplanar waveguide structure, wiring between the plurality of functional circuits 340 can be simpler, and production costs of the feeding apparatus can be reduced.

In some embodiments, the substrate 310 may include one or more cable outlets 312. The one or more cable outlets 312 may be disposed on a periphery of the substrate 310, and are configured to connect the signal line 311 to an antenna element or another radio frequency system. A cable outlet structure used by the cable outlet 312 may be a coaxial cable.

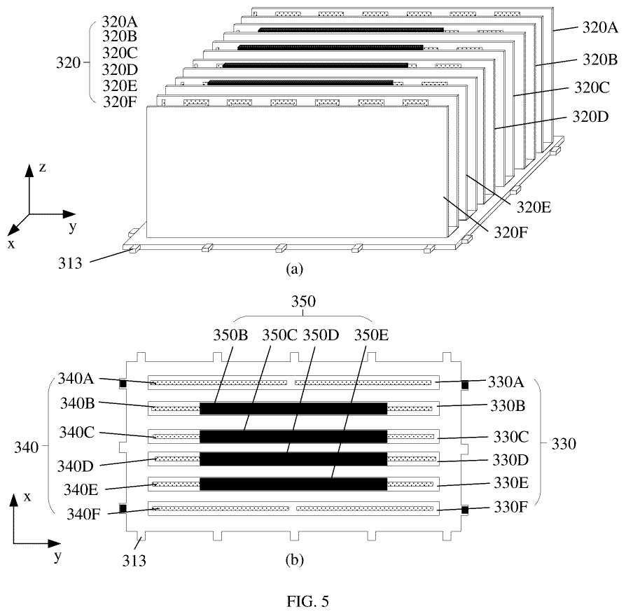

The feeding apparatus shown in FIG. 3 and FIG. 4 includes one housing 320, and the housing 320 may be of a multi-cavity structure. The housing 320 may alternatively be of a single-cavity structure, and the feeding apparatus may include a plurality of single-cavity housings 320 respectively configured to accommodate a plurality of functional circuits 340. For example, refer to a structure of a feeding apparatus shown in FIG. 5. (a) in FIG. 5 is a diagram of a three-dimensional structure of the feeding apparatus, and (b) in FIG. 5 is a top view of the feeding apparatus.

The feeding apparatus may include a plurality of housings 320, for example, six housings 320A to 320F shown in the figure, and the plurality of housings 320 may be disposed on a same principal plane of the substrate 310. That the plurality of housings 320 are disposed on the same principal plane of the substrate 310 can easily implement one-time welding of the plurality of housings 320, improve production and processing efficiency of the feeding apparatus, help implement miniaturization of the feeding apparatus, and reduce a size of the feeding apparatus. Each of the plurality of housings 320 may be of a semi-open structure shown in the figure, or may be of a closed structure. Each housing 320 may include one cavity 330. In other words, each housing 320 may include one bottom wall 322 and two side walls 321, and the one bottom wall 322 and the two side walls 321 may enclose a “U”-shaped structure. A plurality of functional circuits 340A to 340F may be respectively accommodated in a plurality of cavities 330A to 330F of the plurality of housings 320A to 320F.

Similar to the structure shown in FIG. 3, the feeding apparatus may include a sliding medium 350. There may be one or more sliding media 350, for example, four sliding media 350B, 350C, 350D, and 350E shown in FIG. 5. The four sliding media 350 may be respectively accommodated in the four cavities 330B, 330C, 330D, and 330E, and may respectively form four phase shift modules with the housings 320 and the functional circuits 340 corresponding to the cavities 330. For example, the sliding medium 350B may together constitute one phase shift module with the housing corresponding to the cavity 330B in which the sliding medium 350B is located, and the functional circuit 340B in the cavity 330B.

The feeding apparatus may further include a power division module, and the power division module may include the functional circuit 340 and the housing 320. For example, a stripline 340A and a strip 340F are respectively accommodated in the cavities 330A and 330F shown in the figure. The strip 340A and the housing 320 corresponding to the cavity 330A together constitute one power division module. Similarly, the strip 340F and the housing 320 corresponding to the cavity 330F may also together constitute one power division module.

In some embodiments, the substrate 310 may alternatively be connected to an antenna element or another radio frequency module through a pin 313. The pin 313 may be disposed on a periphery of the substrate 310, and the pin 313 may be a protruding part of the substrate 310, for example, may be a protruding part of a PCB. The protruding part may cover at least a part of the signal line 311, and serve as a cable outlet adapter of the feeding apparatus. The pin 313 may alternatively be in a form of a plus etched pattern (plus etched pattern, PEP) plastic electroplated strip, a sheet metal strip, or the like. PEP is a metallization process technology for forming a complex three-dimensional line on a non-metal surface. The PEP plastic electroplated strip is a metal strip electroplated on a plastic surface, to serve as an outlet adapter of the feeding apparatus. The periphery of the substrate 310 may alternatively include a structure such as a pin hole, to serve as an adapter for connecting to an antenna element or another radio frequency circuit. A structure form of the cable outlet adapter of the feeding apparatus is not limited in this application.

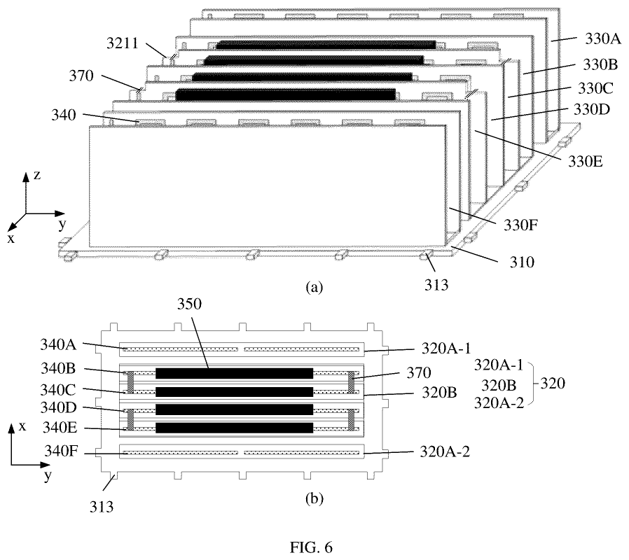

The feeding apparatus may alternatively be combined by one or more single-cavity housings 320 and one or more multi-cavity housings 320, and a plurality of functional circuits 340 may be respectively accommodated in a plurality of cavities 330. In addition to the foregoing phase shift module and functional module, the functional circuit may alternatively together constitute functional modules such as a combiner, a filter, a power division module, and a phase compensation module with the housing 320, and the foregoing functional modules may be combined, so that the feeding apparatus can implement a plurality of different functions. For details, refer to examples shown in FIG. 6 to FIG. 9. Similarly, (a) in FIG. 6 to FIG. 9 is a diagram of a three-dimensional structure of the feeding apparatus, and (b) in FIG. 6 to FIG. 9 is a top view of the feeding apparatus.

First, according to the feeding apparatus shown in FIG. 6, the feeding apparatus may include one multi-cavity housing 320 and two single-cavity housings 320. The multi-cavity housing 320 may be disposed between the two single-cavity housings 320 in an x direction shown in the figure. The multi-cavity housing 320 is, for example, a four-cavity housing 320 shown in the figure. Similar to the foregoing descriptions, functional circuits 340 and sliding media 350 that are accommodated in the multi-cavity housing 320 may together constitute four phase shift modules with the housing 320. Details are not described herein again.

A side that is of the housing 320 of the feeding apparatus and that is away from the substrate 310 may further include an opening part 3211. For example, the opening part 3211 may be disposed at an upper right corner and an upper left corner of the side wall 321 of the multi-cavity housing 320, where “left” and “right” may mean a left side and a right side in a y-axis direction shown in the figure. The opening part 3211 may be configured to pass through a connecting line 370 to connect functional circuits 340 in two adjacent cavities 330. In other words, striplines of the plurality of functional circuits 340 may be led out from the bottom of the housing 320 for electrical connection. For example, openings are disposed at corresponding positions on the bottom wall 322 of the housing 320 and the substrate 310, so that the striplines are connected to the signal line 311. The plurality of functional circuits 340 may alternatively be led out from the top of the housing 320 for electrical connection.

The connecting line 370 may be bent parts of functional circuits 340 in two adjacent cavities 330. For example, the functional circuits 340 in the two adjacent cavities 330 may be bent at the ends, and are connected through the opening part 3211, to implement connection between the functional circuits 340 in the two adjacent cavities 330. Alternatively, only one of two adjacent functional circuits 340 may include a bent part, and is connected to the other functional circuit through the opening part 3211. That the functional circuit 340 includes the bent part and the bent part passes through the opening part for connection can reduce use of parts of the feeding apparatus, and further implement miniaturization of the feeding apparatus.

It should be noted that, in the feeding apparatus shown in FIG. 6, the connecting line 370 is disposed in a housing 320B having a plurality of cavities to connect functional circuits 340 in two adjacent cavities 330, and any two functional circuits 340 in the feeding apparatus may be electrically connected through the connecting line 370. For example, a functional circuit 340 in the multi-cavity housing 320B may also be electrically connected to a functional circuit 340 in a single-cavity housing 320A-1 and/or a functional circuit 340 in a single-cavity 320A-2. This is not limited in this application. The opening part 3211 may alternatively be disposed at a position other than a corner on the side wall 321 of the housing 320, for example, disposed at a middle position on a side that is of the side wall 321 and that is away from the substrate 310, or disposed at any position on a side that is of the side wall 321 and that is perpendicular to the principal plane of the substrate 310. This is not limited in this application.

The functional circuits 340 accommodated in the two single-cavity housings 320A-1 and 320A-2 may together constitute a phase compensation module with the housing 320. For example, a functional circuit in a cavity 330A may together constitute one phase compensation module with the housing 320A-1 corresponding to the cavity 330A, and a functional circuit 340 in a cavity 330F may also together constitute one phase compensation module with the housing 320A-2 corresponding to the cavity 330. The phase compensation module may be configured to adjust a phase of the feeding apparatus.

Similar to the feeding apparatus shown in FIG. 5, the feeding apparatus may further include a power division module, the power division module may be formed by the signal line 311 in the feeding apparatus, and the power division module may be, for example, disposed on a lower plane of the substrate 310. The feeding apparatus may also include a phase shift module, and the phase shift module may be formed by the housings, the functional circuits, and the sliding media 350 corresponding to the cavities 340B to 340E.

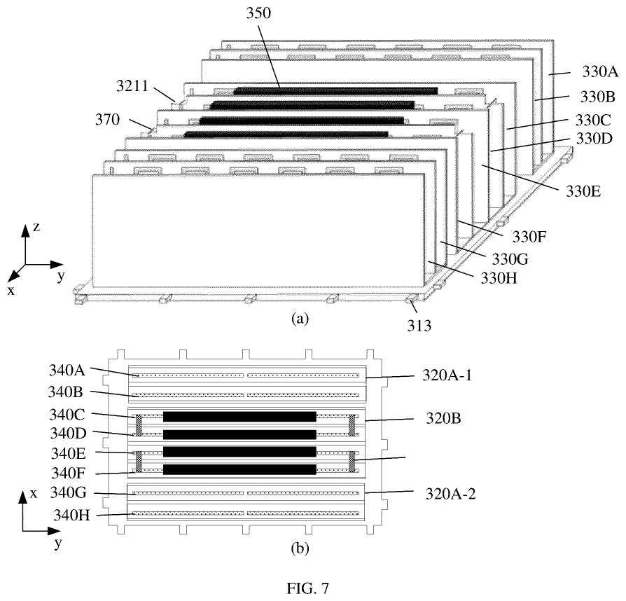

The feeding apparatus shown in FIG. 7 may be combined by a plurality of multi-cavity housings 320, and in addition to the phase shift module, the feeding apparatus may further include a main feed module and a combiner.

For example, the feeding apparatus may include three multi-cavity housings 320A-1, 320A-2, and 320B. The two housings 320A-1 and 320A-2 located on upper and lower sides of the feeding apparatus may be dual-cavity housings. The multi-cavity housing 320A-1 may include cavities 330A and 330B, a functional circuit 340 in the cavity 330B and a part of housing 320 corresponding to the cavity 330B may together constitute one main feed module, to transmit an electrical signal, for example, to transmit a signal sent by an RRU to an antenna, and a functional circuit 340 in the cavity 330A and a part of housing 320 corresponding to the cavity 330A may together constitute one combiner, to combine signals transmitted by the main feed module.

Similarly, the multi-cavity housing 320A-2 may include cavities 330G and 330H, a functional circuit in the cavity 330G and a part of housing 320 corresponding to the cavity 330G may together constitute one main feed module, and a functional circuit in the cavity 330H and the housing 320 corresponding to the cavity 330H may together constitute one combiner, to combine signals transmitted by the main feed module, for output.

The multi-cavity housing 320B may include four cavities 330C, 330D, 330E, and 330F shown in the figure. Similar to the feeding apparatus shown in FIG. 6, a functional circuit 340 in the multi-cavity housing 320B, a sliding medium 350, and a part of housing of a corresponding cavity may together constitute a phase shift module. Details are not described herein again.

Similar to the foregoing feeding apparatus, the signal line 311 of the feeding apparatus may also form a functional module such as a power division module of the feeding apparatus. Other components of the feeding apparatus are similar to those of the feeding apparatus shown in FIG. 3. Details are not described herein again.

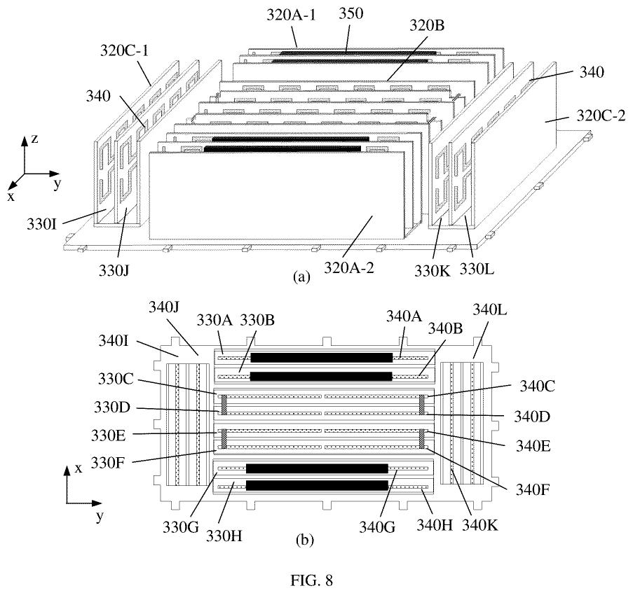

In the feeding apparatus shown in FIG. 3 to FIG. 7, a plurality of cavities 330 enclosed by one or more housings 320 are cavities 330 that are parallel to each other, that is, side walls 321 of the housings may be parallel structures. In the feeding apparatus shown in FIG. 8, a plurality of cavities 330 may include cavities 330 that are perpendicular to each other.

As shown in FIG. 8, the phase shift module may be disposed at two ends that are close to the substrate 310 and that are in an x-axis direction, that is, the phase shift module may be disposed in housings 320A-1 and 320A-2 shown in the figure. The housings 320A-1 and 320A-2 may be of dual-cavity structures. There may be four phase shift modules, as shown in the figure. Similar to the foregoing descriptions, the phase shift module may be jointly formed by a functional circuit 340, a sliding medium 350, and a part of housing 320 of a corresponding cavity 330. Details are not described herein again.

A functional circuit 340 in a housing 320B and a corresponding housing 320 may together constitute a combiner. The housing 320B may be a four-cavity housing, so that four combiners can be formed. For example, a functional circuit 340C and a part of housing 320 of a corresponding cavity 330C may together constitute one combiner. Similarly, a functional circuit 340D and a part of housing 320 of a corresponding cavity 330D may together constitute one combiner, a functional circuit 340E and a part of housing 320 of a corresponding cavity 330E may together constitute one combiner, and a functional circuit 340F and a part of housing 320 of a corresponding cavity 330F may together constitute one combiner.

Cavities 330A to 330H may be cavities that are parallel to each other, that is, a plurality of side walls 321 corresponding to the cavities 330A to 330H may be disposed in parallel to each other. A housing may alternatively be disposed at a position close to left and right sides of the substrate 310. For example, housings 320C-1 and 320C-2 shown in the figure may be disposed. The housings 320C-1 and 320C-2 may be of dual-cavity structures. For example, the housing 320C-1 on the left side may include cavities 330I and 330J, and the housing 320C-2 on the right side may include cavities 330K and 330L. Extension directions of the cavities 330I to 330L may be perpendicular to extension directions of the cavities 330A to 330H. In other words, the extension directions of the cavities 330I to 330L may be an x-axis direction shown in the figure, the extension directions of the cavities 330A to 330H may be a y-axis direction shown in the figure, and the side walls 321 corresponding to the cavities 330I to 330L may be perpendicular to the side walls 321 corresponding to the cavities 330A to 330G.

Functional circuits may also be disposed in the cavities 330I to 330L. For example, the functional circuits in the cavities 330I to 330L and housing parts of corresponding cavities may together constitute combiners, to combine signals transmitted by the feeding apparatus.

The functional circuits are disposed in the cavities 330I to 330L to implement functions that can be implemented by functional modules such as combiners, so that space occupied by the functional circuits on the feeding apparatus can be reduced on a premise that the feeding apparatus can integrate a plurality of functional modules, thereby implementing miniaturization of the feeding apparatus and effectively reducing a size of an antenna system.

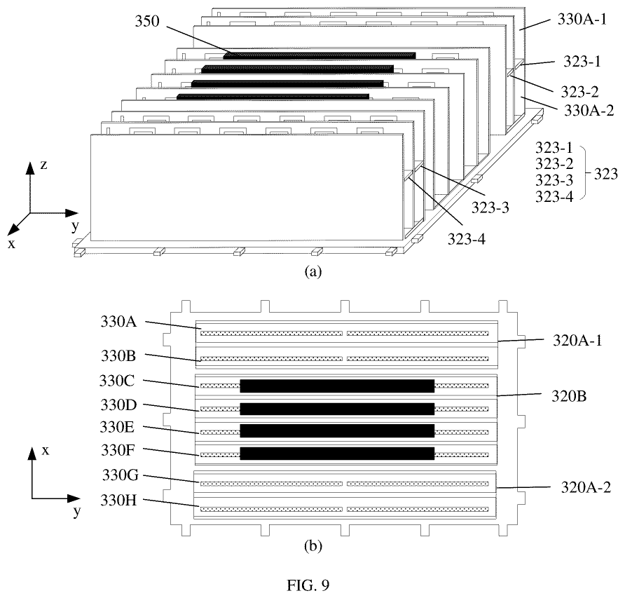

In some embodiments, the housing may further include a spacer 323 that divides a single cavity into at least two parts. For example, refer to a structure of a feeding apparatus shown in FIG. 9.

As shown in FIG. 9, housings 320A-1 and 320A-2 located at two ends of the substrate 310 in an x-axis direction may be dual-cavity housings, and the housings 320A-1 and 320A-2 may include spacers 323. A material of the spacer 323 may be a metal material, and the material of the spacer 323 may be the same as a material of the housing 320. The spacer 323 may be disposed in a cavity 330, and divide the corresponding cavity into a plurality of parts. The spacer 323 may be parallel to the substrate 310. For example, a cavity 330A may include a spacer 323-1, a cavity 330B may include a spacer 323-2, and the spacers 323-1 and 323-2 may be parallel to the substrate 310. Spacers 323 in a same housing 320 may be disposed at a same height or different heights, or spacers 323 in different cavities 330 may be disposed at a same height or different heights. For example, the spacer 323-1 and the spacer 323-2 shown in the figure may be disposed at a same position of the housing 320A-1 in a z-axis direction, making the housing 320A-1 form a semi-open grid structure, or may be disposed at different positions in the z-axis direction.

The spacer 323 may divide the cavity 330 into two parts: an upper part and a lower part. The cavity 330A is used as an example. The cavity 330A may be divided into a first part 330A-1 and a second part 330A-2. Functional circuits 340 may be disposed in the first part 330A-1 and the second part 330A-2 respectively. Each functional circuit 340 and a corresponding part of housing 320 may form one functional module. For example, the functional circuit 340 in the first part 330A-1 may form one combiner with a side wall 321 corresponding to the first part 330A-1 and the spacer 323, and the functional circuit 340 in the second part 330A-2 may form one combiner with a side wall 321 corresponding to the second part 330A-2, the spacer 323, and the bottom wall 322. A functional module formed by the functional circuit 340 in the first part 330A-1 and a functional module formed by the functional circuit 340 in the second part 330A-2 may be a same functional module, or may be different functional modules. Disposition of a spacer in a cavity 330B and disposition of a functional circuit in a corresponding cavity may be similar to those in the cavity 330A, and details are not described herein again.

Similarly, the housing 320A-2 may also include a spacer 323, for example, include a spacer 323-3 and a spacer 323-4 shown in the figure. The spacer 323-3 and the spacer 323-4 may be respectively accommodated in cavities 330E and 330F, and the spacer 323-3 and the spacer 323-4 may be parallel to the substrate 310. Disposition of a functional module in the housing 320A-2 may be similar to that in the housing 320A-1, and details are not described herein again. One spacer 323 may be disposed in one cavity 330, or a plurality of spacers 323 may be disposed in one cavity 330, to divide the cavity 330 into a plurality of parts, so as to fully use surface space on the substrate 310 and implement miniaturization of the feeding apparatus. Functional circuits 340 accommodated in a plurality of parts into which one cavity 330 is divided may form a same functional module or may form different functional modules with the housing 320.

A spacer is disposed in a cavity, to divide the cavity into a plurality of parts, so that three-dimensional wiring of the feeding apparatus can be implemented, and utilization of surface space of the feeding apparatus can be improved. For example, striplines disposed in a flat manner may be vertically disposed, to reduce a surface area occupied by the striplines, thereby further promoting miniaturization of the feeding apparatus.

It should be noted that, in the feeding apparatus described in FIG. 3 to FIG. 9, a structure of the feeding apparatus is mainly described by using an example in which a functional circuit and a housing together constitute a functional module such as a phase shift module, a power division module, a phase compensation module, or a combiner. Alternatively, the functional circuit and the housing may together constitute a functional module such as a filter or a duplexer. This is not limited in this application. In addition, the feeding apparatus may not only include one or a combination of two of the foregoing modules, but also integrate three or more functional modules, to implement expansion and derivation of functions of the feeding apparatus.

The housing in the foregoing embodiments may be a single-cavity housing or a multi-cavity housing. A quantity of single-cavity housings and a quantity of multi-cavity housings, a quantity of cavities included in the multi-cavity housing, and a quantity of functional modules disposed in each cavity are not limited in embodiments of this application, and may be set according to an actual use requirement.

The foregoing embodiments are described by using an example in which the housing includes cavities that are parallel to and/or perpendicular to each other. The housing may alternatively be arranged in any other form. For example, a plurality of cavities may alternatively be distributed on the substrate at an included angle. The housing of the feeding apparatus provided in this application may be flexibly arranged according to an actual function requirement, to fully use surface space of the substrate and integrate a plurality of functional modules. A structural form of the housing and a manner of arranging the housing on the substrate are not limited in this application.

An embodiment of this application further provides an antenna system. The antenna system may include any feeding apparatus described in FIG. 3 to FIG. 9. The antenna system may further include an antenna element. The feeding apparatus may be connected to the antenna element. There may be one or more antenna elements.

An embodiment of this application further provides a base station. The base station may include the foregoing antenna system and a radio frequency module connected to the antenna system.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A feeding apparatus, comprising:
a substrate, wherein the substrate comprises a signal line, and the signal line is configured for electrical signal transmission;
a housing, wherein the housing is disposed on the substrate, the housing comprises a bottom wall and a side wall, and the side wall and the bottom wall enclose a plurality of cavities; and
a plurality of functional circuits, wherein the plurality of functional circuits are respectively accommodated in the plurality of cavities, planes on which the functional circuits are located are perpendicular to the substrate, and the functional circuits are connected to the signal line through a stripline.

2. The feeding apparatus according to claim 1, wherein the housing further comprises a spacer, the spacer is disposed in the cavity, and the spacer divides the cavity into a plurality of parts.

3. The feeding apparatus according to claim 1, wherein the plurality of cavities comprise a first cavity and a second cavity, and an extension direction of the first cavity is parallel to or perpendicular to an extension direction of the second cavity.

4. The feeding apparatus according to claim 1, wherein a side that is of the housing that is away from the substrate comprises an opening part; and
two adjacent functional circuits respectively comprise bent parts, and the bent parts of the two adjacent functional circuits are connected through the opening part.

5. The feeding apparatus according to claim 1, wherein there are a plurality of housings, and the plurality of housings are disposed on a same principal plane of the substrate.

6. The feeding apparatus according to claim 1, wherein the feeding apparatus further comprises a sliding medium, and the sliding medium is slidable relative to the plurality of functional circuits.

7. The feeding apparatus according to claim 1, wherein the functional circuit and a corresponding housing together constitute a functional module, and the functional module comprises at least one of the following modules: a phase shift module, a power division module, a phase compensation module, a main feed module, a combiner, or a filter.

8. The feeding apparatus according to claim 1, wherein the signal line is further configured to form at least one of the following functional modules of the feeding apparatus: a power division module, a phase compensation module, a main feed module, a combiner, a filter, and a transit network.

9. The feeding apparatus according to claim 1, wherein the substrate further comprises a ground plane, and the bottom wall is electrically connected to the ground plane.

10. The feeding apparatus according to claim 9, wherein the signal line and the ground plane are located on a same principal plane of the substrate, and the signal line and the ground plane form a coplanar waveguide structure; or
the signal line and the ground plane are respectively located on different principal planes of the substrate, and the signal line and the ground plane form a microstrip or stripline structure.

11. The feeding apparatus according to claim 1, wherein the housing comprises a first opening, and the strip passes through the first opening to electrically connect to the signal line.

12. The feeding apparatus according to claim 11, wherein the substrate comprises a second opening, the second opening extends in a direction perpendicular to the principal plane of the substrate, and the strip passes through the first opening and the second opening to electrically connect to the signal line.

13. The feeding apparatus according to claim 1, wherein the substrate comprises one or more cable outlets, and the cable outlet is disposed on a periphery of the substrate and is configured to connect the signal line to an antenna element or another radio frequency system; or
the substrate comprises one or more pins, and the pin is disposed on a periphery of the substrate and is configured to connect the signal line to an antenna element or another radio frequency system.

14. An antenna system, comprising the feeding apparatus and one or more antenna elements, wherein the one or more antenna elements are connected to the feeding apparatus,
wherein the feeding apparatus, comprises:
a substrate, wherein the substrate comprises a signal line, and the signal line is configured for electrical signal transmission;
a housing, wherein the housing is disposed on the substrate, the housing comprises a bottom wall and a side wall, and the side wall and the bottom wall enclose a plurality of cavities; and
a plurality of functional circuits, wherein the plurality of functional circuits are respectively accommodated in the plurality of cavities, planes on which the functional circuits are located are perpendicular to the substrate, and the functional circuits are connected to the signal line through a stripline.

15. The antenna system according to claim 14, wherein the housing further comprises a spacer, the spacer is disposed in the cavity, and the spacer divides the cavity into a plurality of parts.

16. The antenna system according to claim 14, wherein the plurality of cavities comprise a first cavity and a second cavity, and an extension direction of the first cavity is parallel to or perpendicular to an extension direction of the second cavity.

17. The antenna system according to claim 14, wherein a side that is of the housing that is away from the substrate comprises an opening part; and
two adjacent functional circuits respectively comprise bent parts, and the bent parts of the two adjacent functional circuits are connected through the opening part.

18. The antenna system according to claim 14, wherein there are a plurality of housings, and the plurality of housings are disposed on a same principal plane of the substrate.

19. The antenna system according to claim 14, wherein the feeding apparatus further comprises a sliding medium, and the sliding medium is slidable relative to the plurality of functional circuits.

20. The antenna system according to claim 14, wherein the functional circuit and a corresponding housing together constitute a functional module, and the functional module comprises at least one of the following modules: a phase shift module, a power division module, a phase compensation module, a main feed module, a combiner, or a filter.
